(19) United States
(12) Patent Application Publication
(10) Pub. No.: US 2015/0362825 A1
(43) Pub. Date: Dec. 17, 2015

(54) CAMERA CLIP WITH STAND FUNCTION AND CAMERA DEVICE HAVING THE SAME

(71) Applicant: Samsung Electronics Co., Ltd., Gyeonggi-do (KR)

(72) Inventors: Joo Hyung KIM, Seoul (KR); Woo Jung MOON, Seoul (KR); Woo Hyeok JEONG, Seoul (KR)

(73) Assignee: Samsung Electronics Co., Ltd.

(21) Appl. No.: 14/740,958

(22) Filed: Jun. 16, 2015

(30) Foreign Application Priority Data
Jun. 16, 2014 (KR) 10-2014-0072708

(51) Int. Cl. G03B 17/56

(52) U.S. Cl. CPC G03B 17/561

(57) ABSTRACT

A camera clip is provided, which includes a stand function and includes a body part, a clip part, and a stand part. The clip part includes a fixing portion having one side fixed to one side of the body part and a free portion coupled to the fixing portion and configured to return to an original position by an elastic force which is generated by moving the free portion in a direction away from the body part with the fixing portion as a fixing part. The stand part is rotatably coupled to one side of the free portion so as to make a constant angle relative to the free portion.

### PRIORITY

This application claims priority under 35 U.S.C. §119(a) to a Korean Patent Application filed on Jun. 16, 2014 in the Korean Intellectual Property Office and assigned serial number 10-2014-0072708, the entire content of which is incorporated herein by reference.

### BACKGROUND

1. Field of the Invention

The present invention relates to a camera clip with a stand function and a camera device including the same.

2. Description of the Related Art

A conventional clip may be used to fix a target object to external attachments, such as a user's clothes and the like, by attaching a clip to the target object and inserting the external attachment into the clip.

However, the conventional clip is merely attached to a target object without a stand function, which allows the target object to stand on surfaces such as a table, a ground, a shelf, and the like, thereby requiring a separate auxiliary device for the stand function.

### SUMMARY

The present invention has been made to solve at least the above-mentioned problems and/or disadvantages and to provide at least the advantages described below. Accordingly, an aspect of the present invention is to provide a camera clip including a clip capable of attaching a camera to an external attachment and having a stand function allowing a camera to stand on a bottom surface and a camera device including the camera clip.

In accordance with an aspect of the present invention, a camera clip is provided, which has a stand function and includes a body part, a clip part, and a stand part. The clip part includes a fixing portion having one side fixed to one side of the body part and a free portion coupled to the fixing portion and configured to return to an original position by an elastic force which is generated by moving the free portion in a direction away from the body part with the fixing portion as a fixing part. The stand part is rotatably coupled to one side of the free portion so as to make a constant angle relative to the free portion.

In accordance with another aspect of the present invention, a camera device is provided, which includes a camera clip and a camera coupled to a body part of the camera clip. The camera clip includes the body part, a clip part, and a stand part. The clip part includes a fixing portion having one side fixed to one side of the body part and a free portion coupled to the fixing portion and configured to return to an original position by an elastic force which is generated by moving the free portion in a direction away from the body part with the fixing portion as a fixing part. The stand part is rotatably coupled to one side of the free portion so as to make a constant angle relative to the free portion.

### BRIEF DESCRIPTION OF THE DRAWINGS

The above and other aspects, features, and advantages of certain embodiments of the present invention will be more apparent from the following description, taken in conjunction with the accompanying drawings, in which:

FIG. 1 is a perspective view illustrating a state in which a camera is coupled to a camera clip according to an embodiment of the present invention;

FIG. 2 is a side view of a camera clip according to an embodiment of the present invention;

FIG. 3 is a front view of a body part of a camera clip according to an embodiment of the present invention;

FIG. 4 is a perspective view illustrating an operating state of a stand part of a camera clip according to an embodiment of the present invention;

FIG. 5 is a cross-sectional view taken along a line A-A′ of FIG. 4;

FIG. 6 is a perspective view illustrating a state in which a camera is coupled to a camera clip according to another embodiment of the present invention;

FIG. 7 is a side view of a camera clip according to another embodiment of the present invention;

FIG. 8 is a perspective view illustrating an operating state of a clip part of a camera clip according to another embodiment of the present invention;

FIG. 9 is a perspective view illustrating an operating state of a stand part of a camera clip according to another embodiment of the present invention; and

FIG. 10 is a block diagram illustrating a configuration of an electronic device according to various embodiments of the present invention.

Throughout the drawings, it should be noted that like reference numbers are used to depict the same or similar elements, features, and structures.

### DETAILED DESCRIPTION OF EMBODIMENTS OF THE PRESENT INVENTION

The following description with reference to the accompanying drawings is provided to assist in a comprehensive understanding of various embodiments of the present invention as defined by the claims and their equivalents. It includes various specific details to assist in that understanding but these are to be regarded merely as examples. Accordingly, those of ordinary skill in the art will recognize that various changes and modifications of the various embodiments described herein can be made without departing from the scope and spirit of the present invention. In addition, descriptions of well-known functions and constructions may be omitted for clarity and conciseness.

The terms “include,” “comprise,” “including,” or “comprising” used herein indicate disclosed functions, operations, or existence of elements, but do not exclude other functions, operations or elements. It should be further understood that the terms “include”, “comprise”, “have”, “including”, “comprising”, or “having” used herein specify the presence of stated features, integers, operations, elements, components, or combinations thereof, but do not preclude the presence or addition of one or more other features, integers, operations, elements, components, or combinations thereof.

The meaning of the terms “or” or “at least one of A and/or B” used herein includes any combination of words listed together with the terms. For example, the expressions “A or B” or “at least one of A and/or B” may indicate A, B, or both A and B.

Terms such as “first”, “second”, and the like used herein may refer to various elements of various embodiments of the present invention, but do not limit the elements. For example, such terms do not limit the order and/or priority of the elements. Furthermore, such terms may be used to distinguish one element from another element. For example, “a first user device” and “a second user device” indicate different user devices. For example, without departing the scope of the present invention, a first element may be referred to as a second element, and similarly, a second element may be referred to as a first element.

In the description below, when one part (or element, device, etc.) is referred to as being “connected” to another part (or element, device, etc.), it should be understood that the former can be “directly connected” to the latter, or “electrically connected” to the latter via an intervening part (or element, device, etc.). It will be further understood that when one component is referred to as being “directly connected” or “directly linked” to another component, it means that no intervening component is present.

The term “module” used herein may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” according to various embodiments of the present invention may include at least one of an application-specific IC (ASIC) chip, a field-programmable gate array (FPGA), and a programmable-logic device for performing some operations, which are known or will be developed.

Terms used in this specification are used to describe embodiments of the present invention and are not intended to limit the scope of the present invention. The terms of a singular form may include plural forms unless otherwise specified.

Unless otherwise defined herein, all the terms used herein, which include technical or scientific terms, may have the same meaning that is generally understood by a person skilled in the art. It will be further understood that terms, which are defined in a dictionary and commonly used, should also be interpreted as being customary in the relevant related art and not in an idealized or overly formal sense unless expressly so defined herein in describing various embodiments of the present invention.

Electronic devices according to various embodiments of the present invention may include a metal case. For example, the electronic devices may include at least one of smartphones, tablet personal computers (PCs), mobile phones, video telephones, electronic book readers, desktop PCs, laptop PCs, netbook computers, personal digital assistants (PDAs), portable multimedia players (PMPs), Motion Picture Experts Group (MPEG-1 or MPEG-2) Audio Layer 3 (MP3) players, mobile medical devices, cameras, wearable devices (e.g., head-mounted-devices (HMDs), such as electronic glasses), an electronic apparel, electronic bracelets, electronic necklaces, electronic appcessories, electronic tattoos, smart watches, and the like.

According to various embodiments of the present invention, the electronic devices may be smart home appliances including metal cases. The smart home appliances may include at least one of, for example, televisions (TVs), digital versatile disc (DVD) players, audios, refrigerators, air conditioners, cleaners, ovens, microwave ovens, washing machines, air cleaners, set-top boxes, TV boxes (e.g., Samsung HomeSync™, Apple TV™, or Google TV™), game consoles, electronic dictionaries, electronic keys, camcorders, electronic picture frames, and the like.

Hereinafter, an electronic device and a clip applicable to thereto, according to various embodiments of the present invention will be described with reference to the accompanying drawings. The term “user” used herein may refer to a person who uses an electronic device (e.g., a camera) or may refer to a device (e.g., an artificial electronic device) that uses an electronic device.

According to various embodiments of the present invention, a camera device 200 may include a camera clip 100 which is part of the camera device 200, or which may be a separate component that is detachable from the camera device 200. The camera clip 100 may include a body part 110, a clip part 120 fixed to one side of the body part 110 and returning to an original position by elasticity, and a stand part 130 rotatably coupled to the clip part 120.

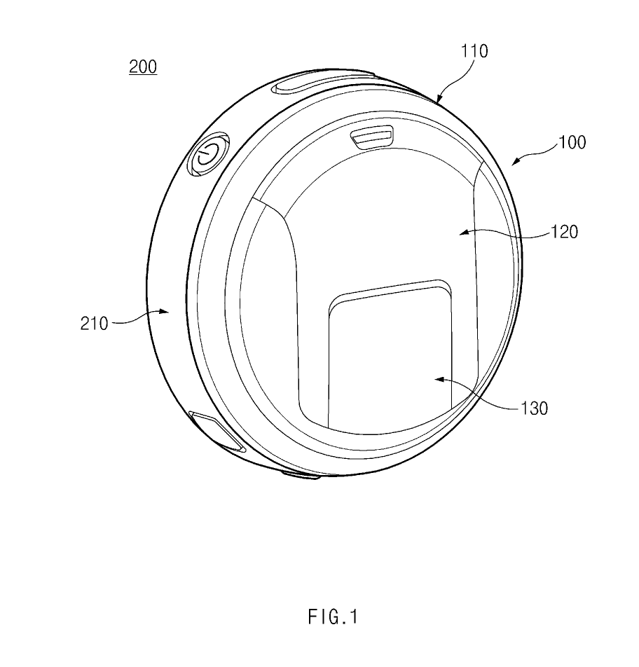

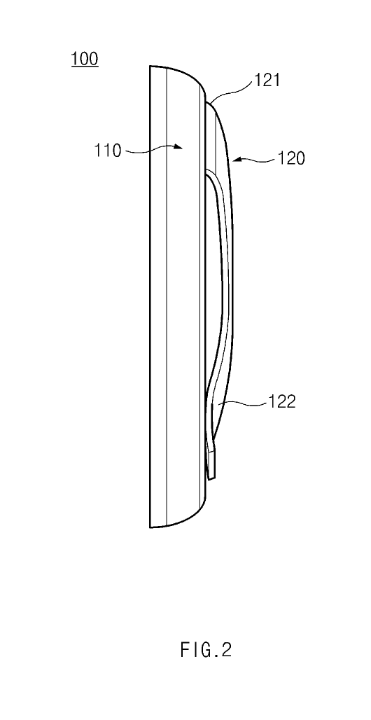

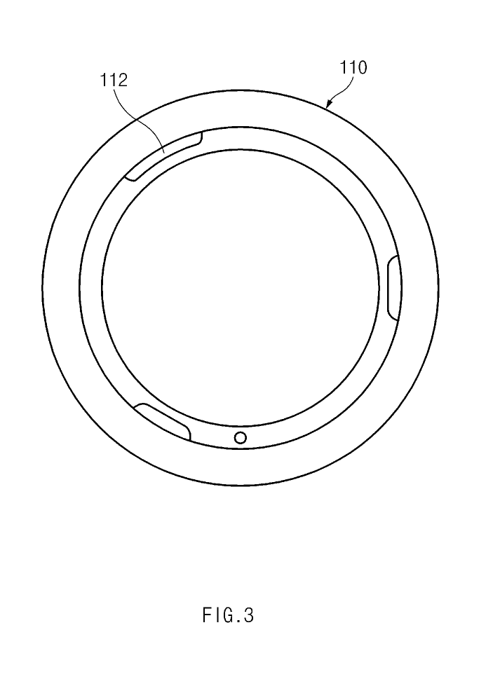

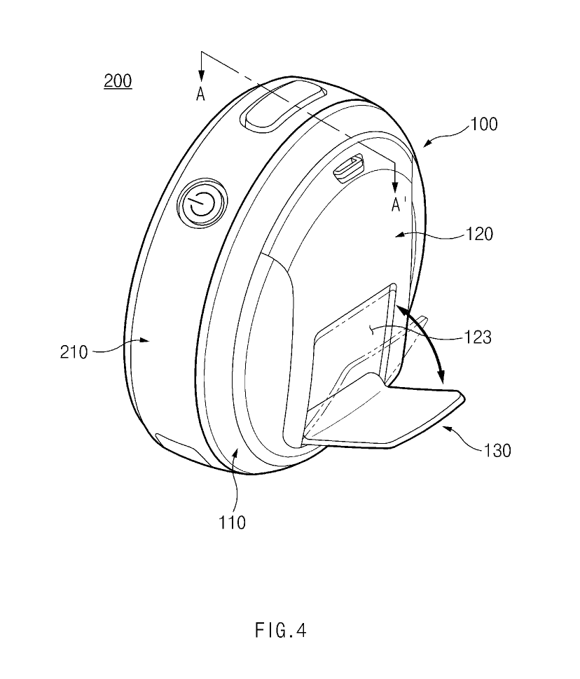

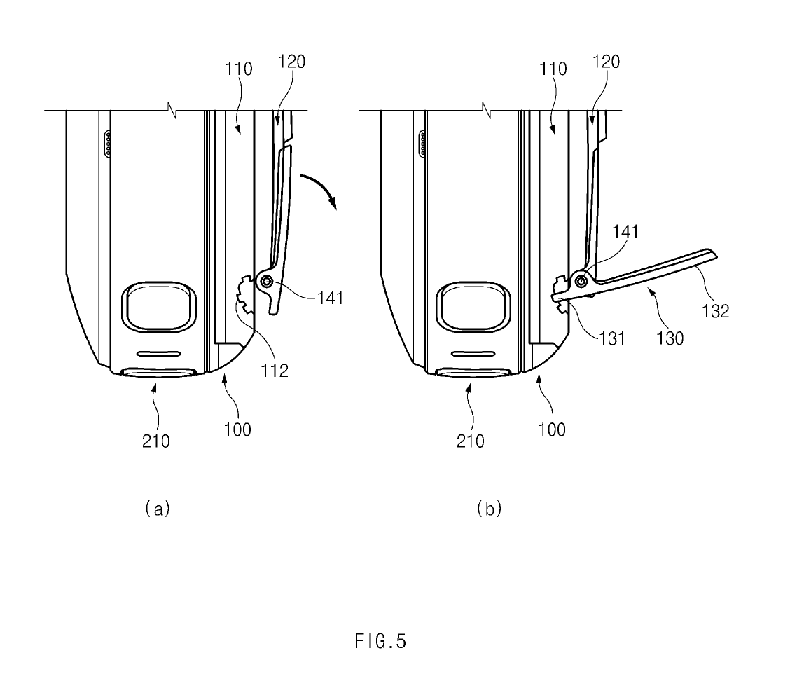

FIGS. 1-5 illustrate the camera clip 100 included in camera device 200 the according to an embodiment of the present invention. Specifically, FIG. 2 is a side view of the camera clip 100, FIG. 3 is a front view of the body part 110, FIG. 4 illustrates an operating state of a stand part 130 of the camera clip 100, and FIG. 5 is a cross-sectional view taken along a line A-A′ of FIG. 4.

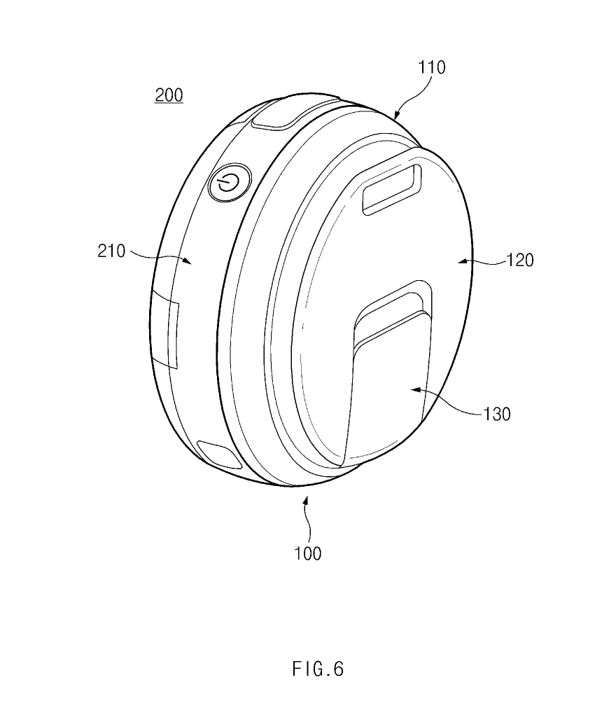

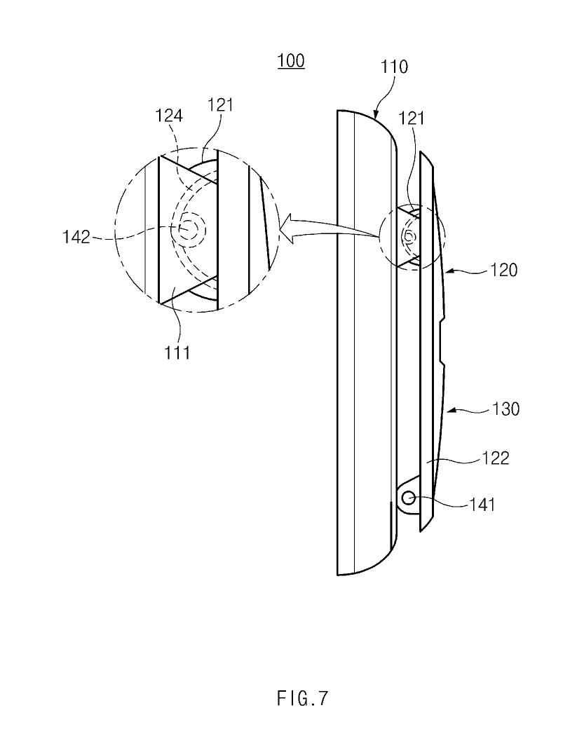

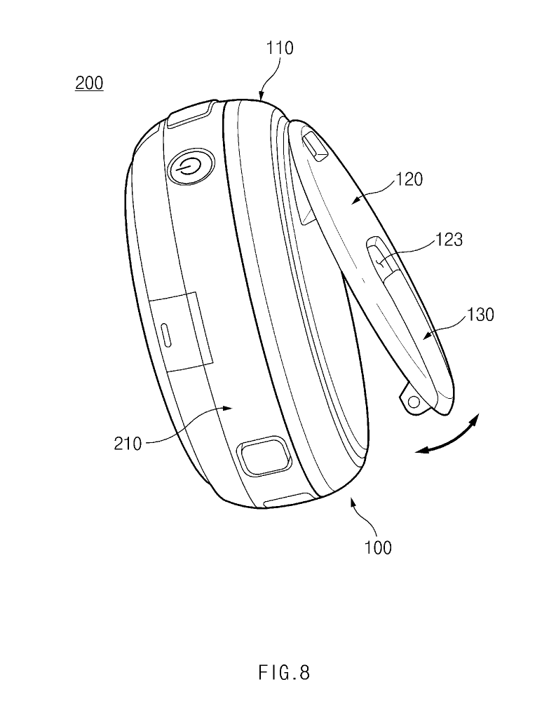

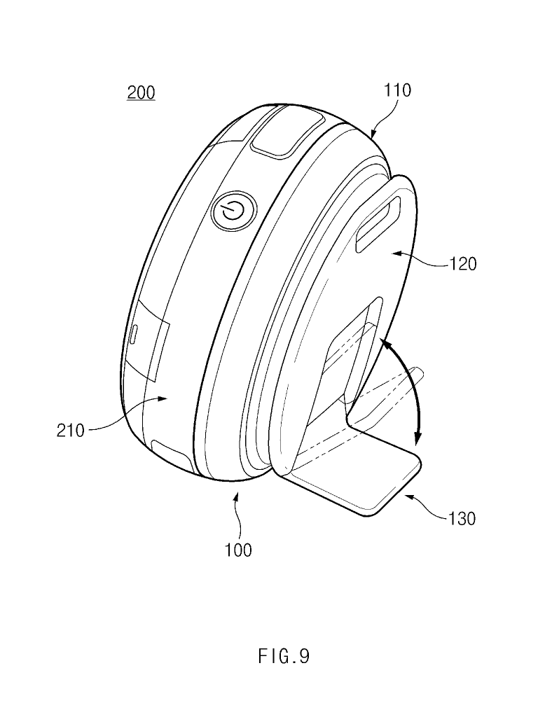

FIGS. 6-9 illustrate the camera clip 100 included in camera device 200 the according to another embodiment of the present invention. Specifically, FIG. 7 is a side view of the camera clip 100, FIG. 8 illustrates an operating state of the clip part 120, and FIG. 9 illustrates an operating state of a stand part 130 of the camera clip 100.

Referring to FIGS. 1 and 6, the body part 110 may have a shape corresponding to that of a camera 210 coupled to one side thereof. For example, when a shape of the camera 210 is circular, the body part 110 may have a circular shape.

The clip part 120 may be provided at the other side of the body part 110 to fix the camera 210 coupled to the body part 110 to clothes, a bookshelf, and the like.

According to an embodiment of the present invention, referring to FIG. 2, the clip part 120 may include a fixing portion 121 fixed to one side (for example, one surface) of the body part 110 and formed in a direction parallel to the surface of the body part 110, and a free portion 122 coupled to the fixing portion 121. When the free portion 122 moves toward a direction away from the body part 110 with the fixing portion 121 being fixed, the free portion 122 may return to an original position by elasticity generated by the movement of the free portion 122.

Referring to FIGS. 1 and 2, the fixing portion 121 may be integrated with the body part 110 as one body. In the clip part 120, the fixing portion 121, as one side of the clip part 120, may be fixed to the body part 110, and a free portion 122, as the other side of the clip part 120, may be provided not to be fixed to the body part 110.

When the free portion 122 undergoes an external force toward a direction away from the body part 110, an elastic force (tension) may be generated, which allows the free part 122 to return to its original position before undergoing deformation, by the fixing portion 121.

According to an embodiment of the present invention, when the free portion 122 undergoes an external force toward a direction away from the body part 110, that is, when a user's collar, a book, or the like is inserted between the body part 110 and the clip part 120, the elastic force may be generated, thereby making it possible to maintain the user's collar, the book, or the like inserted.

According to an embodiment of the present invention, referring to FIG. 7, the clip part 120 may include a first hinge part 142 hinge-connected to the body part 110. The body part 110 may include a protrusion part 111 protruding toward one side thereof, the fixing portion 121 may protrude toward the protrusion part 111, and the fixing portion 121 and the protrusion part 111 may be hinge-connected by inserting a shaft into the protrusion part 111.

According to various embodiments of the present invention, the first hinge part 142 may have an elastic member 124 providing an elastic force so as to return to an original position when the free portion 122 of the clip part 120 undergoes an external force toward a direction away from the body part 110. For example, the elastic member 124 may be formed of a spring. When one end of the free portion 122 moves in a direction away from the body part 110 and the other end of the free portion 122 moves in the opposite direction, that is, the free portion 122 rotates with respect to the fixing portion 121 coupled with the protrusion part 111, the free portion 122 may return to its original position by elasticity.

In an embodiment illustrated in FIGS. 7 and 8, since the first hinge part 142 is provided, a distance between the body part 110 and the clip part 120 when a user's collar, a book, or the like is inserted between the body part 110 and the clip part 120 may be different from that in an embodiment illustrated in FIG. 2.

Referring to FIGS. 4-5 and 7-9, a stand part 130 may include a second hinge part 141 hinge-connected to one side of the free portion 122. The clip part 120 may include a first groove 123 formed on one side of the clip part 120 to prevent the stand part 130 from protruding from one side surface of the clip part 120 when the stand part 130 is placed on the clip part 120.

The first groove 123 may be disposed in a direction approximately perpendicular to the bottom surface on which the camera device 200 stands. A width of the first groove 123 may be wider than that of the stand part 130, and a length of the first groove 123 may be longer than that of the stand part 130.

Referring to FIGS. 3 and 5, a second groove 112 may be formed on one side of the body part 110 to allow one end of the stand part 130 to be inserted into the body part 110.

At this time, to insert one end 131 of the stand part 130 into the second groove 112, a user may rotate the stand part 130 to allow the stand part 130 to leave from the first groove 123. The user may apply an external force toward a direction away from the body part 110 to the stand part 130. Afterwards, the other end 131 of the stand part 130 may be inserted into the second groove 112 when the rotation of the stand part 130 induced by the external force stops.

As the other end 131 of the stand part 130 is inserted into the second groove 112, the stand part 130 may be fixed even though the external force is removed, and a specific angle is maintained between the stand part 130 and the body part 110. According to various embodiments of the present invention, the second groove 112 may be disposed in plurality at the body part 110 along a direction of the stand part 130 when the stand part 130 rotates. In this case, the body part 110 may be inserted into each of the second grooves 112, and an angle between the stand part 130 and the body part 110 may vary with a groove position where the stand part 130 is inserted.

According to an embodiment of the present invention, referring to FIGS. 8 and 9, an angle between the stand part 130 and the free portion 122 may be continuously adjusted by controlling friction between the stand part 130 and the free portion 122.

According to an embodiment of the present invention, in the second hinge part 141, referring to FIG. 5, friction may occur between a shaft inserted into the stand part 130 and the other part of the stand part 130 surrounding the shaft, and friction may occur between a width-directional end of the stand part 130 and an inner sidewall (or inner side end) of the free portion 122 of the clip part 120. It may be possible to maintain a constant angle between the stand part 130 and the clip part 120 without rotation of the clip part 120 due to gravity when the stand part 130 is placed on the bottom surface on which the camera device 200 stands, by adjusting a frictional force thus generated.

According to various embodiments of the present invention, referring to FIG. 5, the stand part 130 may have a convex shape on an outer surface (i.e., the surface that does not face the free portion 122), and may include a concavo-convex part provided on a outer surface thereof to allow the body part 110 not to slip when the stand part 130 is placed on the bottom surface on which the camera device 200 stands. For example, the concavo-convex part may be provided in a concavo-convex shape in which a concave portion and a convex portion are formed on a surface in a matrix form.

According to various embodiments of the present invention, a camera device 200 may include a camera clip 100 and a camera 210 coupled to the camera clip 100.

According to various embodiments of the present invention, the camera 210 may be a portable camera.

According to various embodiments of the present invention, the camera 210 may be formed as one body including the camera clip 100.

The camera 210 may be provided to be detachable from the camera clip 100. For example, the camera 210 may be coupled to the camera clip 100 using a screw or a bayonet manner.

According to various embodiments of the present invention, when the camera 210 is coupled to the camera clip 100, the camera 210 may be provided to be rotatable. For example, the body part 110 may include a protruding pin in the form of ring, and the camera 210 may include a third groove to allow the pin to be inserted. Accordingly, when the ring is inserted into the third groove, the camera 210 may rotate with the body part 110 coupled thereto.

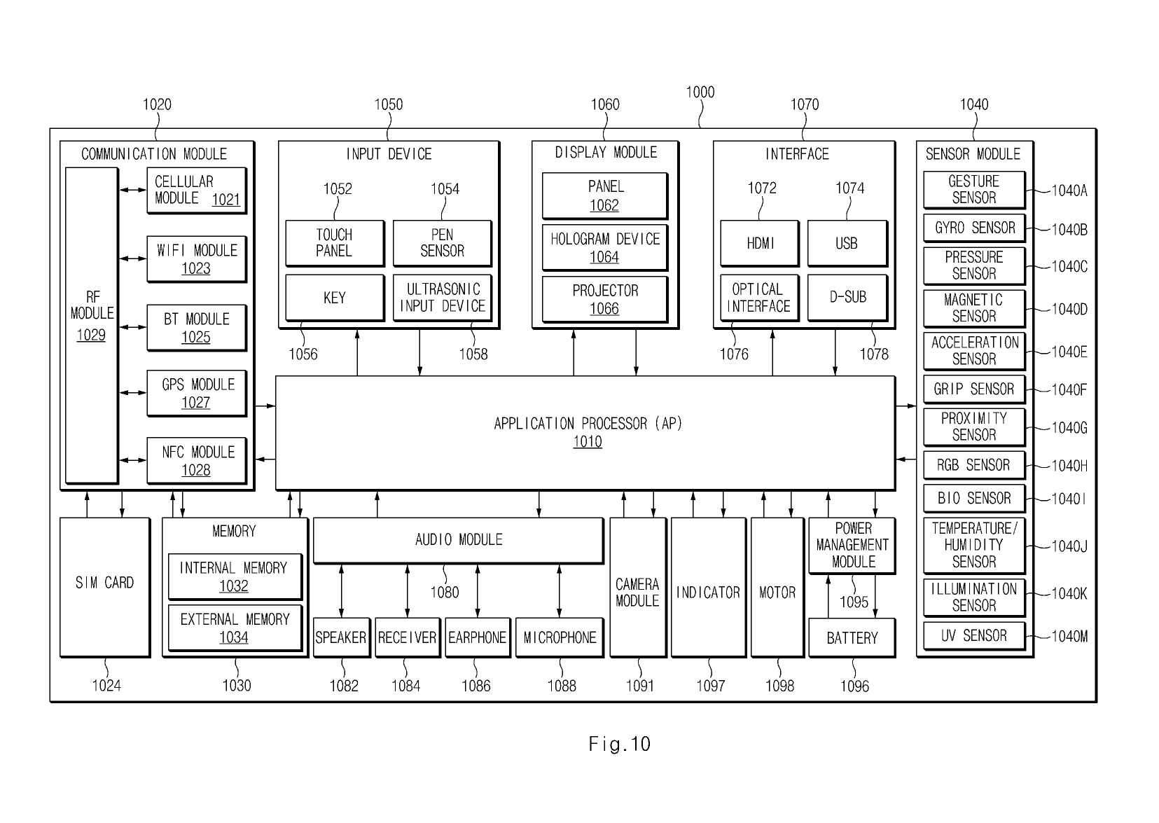

FIG. 10 is a block diagram illustrating an electronic device according to various embodiments of the present invention. An electronic device 1000 may include, for example, a part or all of components of an electronic device illustrated in FIG. 10. Referring to FIG. 10, the electronic device 1000 may include one or more application processors (AP) 1010, a communication module 1020, a subscriber identification module (SIM) card 1024, a memory 1030, a sensor module 1040, an input device 1050, a display module 1060, an interface 1070, an audio module 1080, a camera module 1091, a power management module 1095, a battery 1096, an indicator 1097, and a motor 1098.

The AP 1010 drives an operating system (OS) or an application to control a plurality of hardware or software components connected to the AP 1010 and processes and computes a variety of data including multimedia data. The AP 1010 may be implemented with a System on Chip (SoC), for example. According to an embodiment of the present invention, the AP 1010 may further include a graphic processing unit (GPU).

The communication module 1020 transmits and receives data when there are conveyed communications between other electronic devices connected with the electronic device 1000 through a network. According to an embodiment of the present invention, the communication module 1020 may include a cellular module 1021, a wireless-fidelity (Wi-Fi) module 1023, a Bluetooth (BT) module 1025, a global positioning system (GPS) module 1027, a near field communication (NFC) module 1028, and a radio frequency (RF) module 1029.

The cellular module 1021 provides voice communication, video communication, a character service, an Internet service, and the like through a communication network (e.g., a Long Term Evolution (LTE), an LTE Advanced (LTE-A), a Code Division Multiple Access (CDMA), a Wideband CDMA (WCDMA), a Universal Mobile Telecommunication Systems (UMTS), a Wireless Broadband (WiBro), a Global System for Mobile Communication (GSM), or the like). Also, the cellular module 1021 performs discrimination and authentication of an electronic device within a communication network using a subscriber identification module (e.g., a SIM card 1024), for example. According to an embodiment of the present invention, the cellular module 1021 may perform at least a portion of functions that the AP 1010 provides. For example, the cellular module 1021 may perform at least a portion of a multimedia control function.

According to an embodiment of the present invention, the cellular module 1021 may include a communication processor (CP). Furthermore, the cellular module 1021 may be implemented with, for example, an SoC.

According to an embodiment of the present invention, the AP 1010 or the cellular module 1021 (e.g., a communication processor) loads and processes an instruction or data received from nonvolatile memories respectively connected thereto or from at least one of other elements at the nonvolatile memory. Also, the AP 1010 or the cellular module 1021 stores data received from at least one of other elements or generated by at least one of other elements at a nonvolatile memory.

Each of the Wi-Fi module 1023, the BT module 1025, the GPS module 1027, and the NFC module 1028 may include a processor for processing data exchanged through a corresponding module, for example.

According to an embodiment of the present invention, at least a portion (e.g., two or more components) of the cellular module 1021, the Wi-Fi module 1023, the BT module 1025, the GPS module 1027, and the NFC module 1028 may be included within one Integrated Circuit (IC) or an IC package. For example, at least a portion (e.g., a communication processor corresponding to the cellular module 1021 and a Wi-Fi processor corresponding to the Wi-Fi module 923) of communication processors corresponding to the cellular module 1021, the Wi-Fi module 1023, the BT module 1025, the GPS module 1027, and the NFC module 1028 may be implemented with one SoC.

The RF module 1029 transmits and receives data, for example, an RF signal. Although not illustrated, the RF module 1029 may include a transceiver, a power amplifier module (PAM), a frequency filter, or low noise amplifier (LNA). The RF module 1029 may further include a conductor or a conducting wire for transmitting and receiving an electromagnetic wave in a space in wireless communication.

According to an embodiment of the present invention, at least one of the cellular module 1021, the Wi-Fi module 1023, the BT module 1025, the GPS module 1027, or the NFC module 1028 may transmit and receive an RF signal through a separate RF module.

The SIM card 1024 may be inserted to a slot formed at a specific position of the electronic device 1000. The SIM card 1024 may include unique identify information (e.g., integrated circuit card identifier (ICCID)) or subscriber information (e.g., integrated mobile subscriber identity (IMSI)).

The memory 1030 may include an embedded (or internal) memory 1032 or an external memory 1034. For example, the embedded memory 1032 may include at least one of a volatile memory (e.g., dynamic random access memory (RAM) (DRAM), static RAM (SRAM), synchronous dynamic RAM (SDRAM), etc.), and a nonvolatile memory (e.g., a one-time programmable read only memory (ROM) (OTPROM), a programmable ROM (PROM), an erasable and programmable ROM (EPROM), an electrically erasable and programmable ROM (EEPROM), a mask ROM, a flash ROM, a NAND flash memory, or a NOR flash memory).

According to an embodiment of the present invention, the embedded memory 1032 may be a solid state drive (SSD). The external memory 1034 may include a flash drive, for example, compact flash (CF), secure digital (SD), micro secure digital (Micro-SD), mini secure digital (Mini-SD), extreme digital (xD) or a memory stick. The external memory 1034 may be functionally connected with the electronic device 1000 through various interfaces. According to an embodiment of the present invention, the electronic device 1000 may further include a storage device (or storage medium) such as a hard disk drive.

The sensor module 1040 measures a physical quantity or detects an operation state of the electronic device 901, and converts the measured or detected information to an electric signal. The sensor module 1040 may include at least one of a gesture sensor 1040A, a gyro sensor 1040B, a pressure sensor 1040C, a magnetic sensor 1040D, an acceleration sensor 1040E, a grip sensor 1040F, a proximity sensor 1040G, a color sensor 1040H (e.g., red, green, blue (RGB) sensor), a living body (bio) sensor 1040I, a temperature/humidity sensor 1040J, an illuminance sensor 1040K, or an ultraviolet (UV) sensor 1040M. Alternatively, although not illustrated, the sensor module 1040 may further include, for example, an E-nose sensor, an electromyography sensor (EMG) sensor, an electroencephalogram (EEG) sensor, an electrocardiogram (ECG) sensor, a photoplethysmographic (PPG) sensor, an infrared (IR) sensor, an iris sensor, a fingerprint sensor, and the like. The sensor module 1040 may further include a control circuit for controlling at least one or more sensors included therein.

The input device 1050 may include a touch panel 1052, a (digital) pen sensor 1054, a key 1056, or an ultrasonic input unit 1058. The touch panel 1052 recognizes a touch input using at least one of capacitive, resistive, infrared and ultrasonic detecting methods. Also, the touch panel 1052 may further include a control circuit. In the case of using the capacitive detecting method, a physical contact or proximity recognition is possible. The touch panel 1052 may further include a tactile layer. In this case, the touch panel 1052 may provide a tactile reaction to a user.

The (digital) pen sensor 1054 may be implemented in a similar or same manner as the method of receiving a touch input of a user or may be implemented using an additional sheet for recognition. The key 1056 may include, for example, a physical button, an optical key, or a keypad. The ultrasonic input device 1058, which is an input device for generating an ultrasonic signal, enables the electronic device 1000 to sense or detect a sound wave through a microphone 1088 so as to identify data, and the ultrasonic input device 1058 is capable of wireless recognition. According to an embodiment of the present invention, the electronic device 1000 may use the communication module 1020 so as to receive a user input from an external device (e.g., a computer or server) connected to the communication module 1020.

The display module 1060 may include a panel 1062, a hologram device 1064, or a projector 1066. The panel 962 may be a liquid-crystal display (LCD) or an active-matrix organic light-emitting diode (AMOLED). The panel 964 may be, for example, flexible, transparent or wearable. The panel 1064 and the touch panel 1052 may be integrated into a single module. The hologram device 1064 may display a stereoscopic image in a space using a light interference phenomenon. The projector 1066 may project light onto a screen so as to display an image. The screen may be arranged in the inside or the outside of the electronic device 1000. The display module 1060 may further include a control circuit for controlling the panel 1062, the hologram device 1064, or the projector 1066.

The interface 1070 may include, for example, a high-definition multimedia interface (HDMI) 1072, a universal serial bus (USB) 1074, an optical interface 1076, or a D-sub (D-subminiature) 1078. Alternatively, the interface 1070 may include, for example, a mobile high definition link (MHL) interface, a SD card/multi-media card (MMC) interface, or an infrared data association (IrDA) standard interface.

The audio module 1080 converts a sound and an electric signal in dual directions. The audio module 1080 processes, for example, sound information that is input or output through a speaker 1082, a receiver 1084, an earphone 1086, or the microphone 1088.

The camera module 1091 for shooting a still image or a video may include at least one image sensor (e.g., a front sensor or a rear sensor), a lens, an image signal processor (ISP), or a flash (e.g., a Light Emitting Diode (LED) or a xenon lamp).

The power management module 1095 manages power of the electronic device 1000. Although not illustrated, the power management module 1095 may include, for example, a power management integrated circuit (PMIC) a charger IC, or a battery gauge.

The PMIC may be mounted on an integrated circuit or an SoC semiconductor. A charging method may be classified into a wired charging method and a wireless charging method. The charger IC may charge a battery, and may prevent an overvoltage or an overcurrent from being introduced from a charger. According to an embodiment of the present invention, the charger IC may include a charger IC for at least one of the wired charging method and the wireless charging method. The wireless charging method may include, for example, a magnetic resonance method, a magnetic induction method or an electromagnetic method, and may include an additional circuit, for example, a coil loop, a resonant circuit, or a rectifier, and the like.

The battery gauge measures, for example, a remaining capacity of the battery 1096 and a voltage, current or temperature thereof while the battery is charged. The battery 1096 stores or generates electricity, and supplies power to the electronic device 1000 using the stored or generated electricity. The battery 1096 may include, for example, a rechargeable battery or a solar battery.

The indicator 1097 displays a specific state of the electronic device 1000 or a part thereof (e.g., the AP 1010), such as a booting state, a message state, a charging state, and the like. The motor 1098 converts an electrical signal into a mechanical vibration. Although not illustrated, a processing device (e.g., a GPU) for supporting a mobile TV may be included in the electronic device 901. The processing device for supporting a mobile TV may process media data according to the standards of DMB, digital video broadcasting (DVB) or media flow.

Each of the above-mentioned elements of the electronic device according to various embodiments of the present invention may be configured with one or more components, and the names of the elements may be changed according to the type of the electronic device. The electronic device according to various embodiments of the present invention may include at least one of the above-mentioned elements, and some elements may be omitted or other additional elements may be added. Furthermore, some of the elements of the electronic device according to various embodiments of the present invention may be combined with each other so as to form one entity, so that the functions of the elements may be performed in the same manner as before the combination.

According to various embodiments of the present invention, it may be possible to attach a camera to an external attachment and to stand the camera on a surface without a separate auxiliary means.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. A camera clip with a stand function, comprising:
a body part;
a clip part including a fixing portion having one side fixed to one side of the body part and a free portion coupled to the fixing portion and configured to return to an original position by an elastic force which is generated by moving the free portion in a direction away from the body part with the fixing portion as a fixing part; and
a stand part rotatably coupled to one side of the free portion so as to make a constant angle relative to the free portion.

2. The camera clip of claim 1, wherein the fixing portion of the clip part is formed on the body part as one body.

3. The camera clip of claim 1, wherein the body part comprises a protrusion part protruding toward the clip part,
wherein the clip part comprises a first hinge part for hinge-connecting the fixing portion and the protrusion part, and
wherein the first hinge part comprises an elastic member to provide the elastic force by which the free portion returns to the original position.

4. The camera clip of claim 1, wherein the stand part comprises:
a second hinge part hinge-connected to the one side of the free portion at one side of the stand part.

5. The camera clip of claim 1, wherein the clip part comprises:
a first groove formed on one side of the clip part and configured to prevent the stand part from protruding from the one side of the clip part when the stand part is placed on the clip part.

6. The camera clip of claim 5, wherein the first groove is formed to be longer in length than that of the stand part in a direction perpendicular to a surface on which the camera clip stands, to allow the stand part to be easily removed from the clip part.

7. The camera clip of claim 2, wherein the body part comprises:
a second groove formed on the one side of the body part to allow one end of the stand part to be inserted into the second groove when the stand part rotates.

8. The camera clip of claim 7, wherein the second groove is formed in plurality in a direction of the stand part that is rotatable to adjust an angle between the stand part and the clip part.

9. The camera clip of claim 3, wherein an angle between the stand part and the free portion is continuously adjusted by controlling friction between the free portion and the second hinge part.

10. The camera clip of claim 1, wherein an outer surface of the stand part has a convex shape.

11. The camera clip of claim 1, wherein the stand part comprises:
a concavo-convex portion formed on an outer surface of the stand part to prevent the stand part from sliding.

12. A camera device comprising:
a camera clip; and
a portable camera coupled to the body part,
wherein the camera clip comprises:
a body part;
a clip part including a fixing portion having one side fixed to one side of the body part and a free portion coupled to the fixing portion and configured to return to an original position by an elastic force which is generated by moving the free portion in a direction away from the body part with the fixing portion as a fixing part; and
a stand part rotatably coupled to one side of the free portion so as to make a constant angle relative to the free portion.

13. The camera device of claim 12, wherein the camera clip is integral with the portable camera.

14. The camera device of claim 12, wherein the camera clip is detachably attached to the portable camera.

15. The camera device of claim 13, wherein the body part comprises a protruding pin from one side of the body part in a ring shape to allow the portable camera to rotate upon the portable camera is coupled to the camera clip, and
wherein the portable camera comprises a third groove to allow the pin to be inserted.
